(19) United States
(12) Patent Application Publication
(10) Pub. No.: US 2026/0296140 A1
(43) Pub. Date: Oct. 1, 2026

(54) Thermal Management System, Air Conditioner for a Vehicle, or Heat Pump for a Vehicle, and Such a Vehicle

(71) Applicant: MAHLE International GmbH, Stuttgart (DE)

(72) Inventors: Thorsten Möllert, Stuttgart (DE); Anja Kies, Weil der Stadt (DE); Daniel Schleicher, Esslingen am Neckar (DE); Achim Gommel, Weil der Stadt (DE); Tobias Isermeyer, Löwenstein (DE); Alexander Krumbach, Burgstetten (DE); Stefan Hirsch, Stuttgart (DE); Jorge Curras Guede, Ostfildern (DE)

(21) Appl. No.: 19/573,490

(22) Filed: Mar. 20, 2026

(30) Foreign Application Priority Data
Mar. 31, 2025 (DE) 102025112338.1

(51) Int. Cl. B60H 1/32; B60H 1/00

(52) U.S. Cl. CPC B60H 1/3228; B60H 1/00385

(57) ABSTRACT

A thermal management system for a vehicle, in particular an electric vehicle is provided and contains a refrigerant circuit in which a refrigerant circulates in a predefined direction and which contains a first heat exchanger and a cooling branch through which a secondary refrigerant flow path leads to a compressor. The thermal management system contains a third heat exchanger that is connected to the main refrigerant flow path and the cooling branch and transfers heat from the main flow path to the secondary flow path, and the third heat exchanger and first heat exchanger form an integral unit. The An air conditioner or heat pump for a vehicle is provided that contains at least one such thermal management system and a vehicle that has such an air conditioner or heat pump.

### CROSS-REFERENCE TO RELATED APPLICATIONS

This application claims priority from German Patent Application No. DE 102025112338.1, filed on Mar. 31, 2025, the entirety of which is hereby incorporated by reference herein.

The present invention relates to a thermal management system according to Numbered Paragraph 1. The invention also relates to an air conditioner or heat pump for a vehicle that contains such a thermal management system, and a vehicle with such an air conditioner or heat pump.

Thermal management systems are used to control the temperatures of components, and normally contain a refrigerant circuit. There are heat exchangers in these refrigerant circuits that transfer heat to the refrigerant, or draw heat therefrom, in order to control the temperatures of the components in question. The disadvantage thereby is that current thermal management systems are relatively large, expensive to produce, and difficult to integrate in a vehicle.

The object of the invention is to therefore create a better, or at least different, thermal management system.

This is achieved with the present invention by the subject matter of the independent Numbered Paragraphs. Advantageous embodiments are the subject matter of the dependent Numbered Paragraphs, the description, and the drawing.

Concretely, this object is achieved by a thermal management system for a vehicle, specifically an electric vehicle, which has a refrigerant circuit in which a refrigerant flows in a predefined direction and which has a first heat exchanger for cooling the and condensing the refrigerant. The refrigerant circuit also has a reservoir for drying and/or storing the refrigerant downstream of the first heat exchanger, a second heat exchanger downstream of the reservoir for heating and vaporizing the refrigerant, an expansion valve upstream of the second heat exchanger and downstream of the reservoir, which is preferably operated electromagnetically, and a compressor upstream of the first heat exchanger and downstream of the second heat exchanger for compressing the refrigerant. The refrigerant circuit also has a cooling branch that connects the reservoir to the compressor, through which refrigerant flows from the reservoir to the compressor. This cooling branch has a regulator downstream of the reservoir, in particular a choke, a shutter, or preferably an electric expansion valve for reducing the pressure and temperature of the refrigerant therein. This coordinates the temperature and pressure of the refrigerant upstream of the regulator to that of the refrigerant in the reservoir. After the refrigerant in the cooling branch has been expanded by the regulator, the temperature and pressure of the refrigerant downstream of the regulator is lower than that of the refrigerant upstream thereof. The thermal management system also has a third heat exchanger upstream of the expansion valve and downstream of the reservoir in the refrigerant circuit, and upstream of the compressor and downstream of the regulator in the cooling branch, which transfers heat from the refrigerant to the cooling branch. This further cools the refrigerant exiting the first heat exchanger (condenser) after it has been initially cooled in the first heat exchanger. The advantage with this is that it increases the cooling capacity of the second heat exchanger (evaporator), thus improving the overall performance of the thermal management system. Furthermore, the refrigerant in the third heat exchanger, which is preferably set to an average temperature, is overheated when the relatively highly pressurized refrigerant in the cooling branch is undercooled. The overheated refrigerant is then sprayed into the compressor, further improving the overall performance of the thermal management system, because the compression is more efficient due to the lower compression temperature. The third and first heat exchangers can preferably form an integral unit. Because of this, the thermal management system is relatively inexpensive, compact and light, which is advantageous for vehicles because of the limited installation space and overall weight.

The refrigerant is preferably R290 (propane).

The terms “upstream” and “downstream” relate to the direction in which the refrigerant flows in the refrigerant circuit and the cooling branch.

The refrigerant in the cooling branch can vaporize in the third heat exchanger where the pressure is lower than in the main refrigerant flow path, which is ideally at an average pressure for the thermal management system in the compressor.

The first heat exchanger, third heat exchanger, and reservoir can form an integral unit. Furthermore, the first heat exchanger, third heat exchanger, reservoir, regulator, and at least part of the cooling branch can form an integral unit. This results in a more compact thermal management system.

An “integral unit” is preferably a cohesive unit. It is consequently easy to manipulate as a whole when assembling the thermal management system.

The third heat exchanger preferably generates vapor when vaporizing the refrigerant. Consequently, the temperature and/or pressure of the refrigerant in the cooling branch can be adjusted by the third heat exchanger (evaporator), such that the refrigerant downstream of the third heat exchanger is vaporized, and can be conveyed to the compressor in this state.

The first heat exchanger can be an indirect heat exchanger, ideally a condenser cooled by a liquid. The indirect heat exchanger transfers heat from the refrigerant to a liquid flowing through it.

There can also be a second, preferably magnetically operated, valve in the refrigerant circuit upstream of the first heat exchanger and downstream of the compressor for controlling the flow of refrigerant. This second valve is preferably a shut-off valve, and specifically not an expansion valve. It is used to shut off the refrigerant circuit prior to the first heat exchanger (condenser), in particular for operating the thermal management system in a “hot gas bypass” mode.

The regulator can be a choke, shutter, or electric expansion valve. These are the preferred types of regulators.

The thermal management system can contain a heating circuit through which a refrigerant circulates. This heating circuit can be connected to the compressor. The heating circuit can contain an expansion valve with which the flow of refrigerant in the heating circuit is controlled.

There can also be a first temperature and pressure sensor in the refrigerant circuit, which is upstream of the compressor and downstream of the second heat exchanger. There can also be a second temperature and pressure sensor in the refrigerant circuit, which is upstream of the first heat exchanger and downstream of the compressor. A third pressure and temperature sensor can be placed in the cooling branch, upstream of the compressor and downstream of the third heat exchanger. These sensors can detect the pressures and temperatures of the refrigerant in the refrigerant circuit and the cooling circuit, and generate signals for controlling or regulating the thermal management system.

The above object is also achieved by an air conditioner and/or heat pump for a vehicle, which has at least one thermal management system designed in accordance with the above description.

The above object is also achieved by a vehicle that has an air conditioner or heat pump designed in accordance with the above description.

Further important features and advantages of the invention can be derived from the dependent Numbered Paragraphs, the drawing, and the description of the drawing.

It is understood that the features specified above and explained below can be used not only in the given combinations, but also in other combinations or in and of themselves, without abandoning the scope of protection for the present invention. Components of a higher-order unit specified above and below, e.g. an element, device, or assembly, that are indicated separately, can be separate components thereof or form integral parts thereof, even if the drawing indicates otherwise.

A preferred embodiment of the invention is shown in the drawing and explained in greater detail below, in which the same reference symbols are used for identical, similar, or functionally identical components.

Therein, schematically

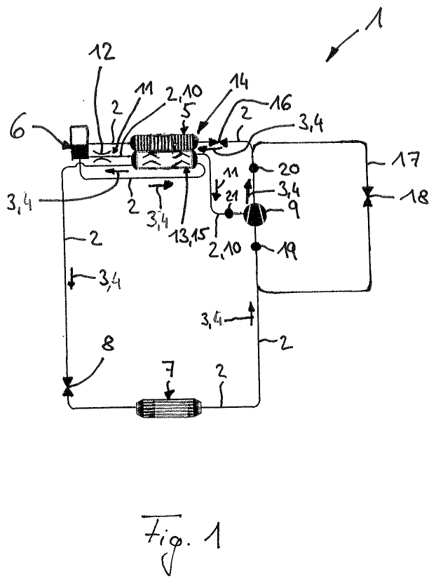

FIG. 1 shows a highly simplified circuit diagram of the thermal management system obtained with the invention.

FIG. 1 shows a thermal management system for a vehicle, indicated as a whole by the numeral 1, e.g. a vehicle air conditioner or heat pump.

The thermal management system 1 contains a refrigerant circuit 2 through which a refrigerant, e.g. R290 (propane), circulates in a predefined direction indicated by arrows 4 in FIG. 1.

The refrigerant circuit 2 contains a first heat exchanger 5, indicated by a simple box, which cools and condenses the refrigerant. The first heat exchanger 5 forms an indirect heat exchanger, preferably a condenser cooled by a liquid, which transfers heat from the refrigerant to a liquid flowing through the first heat exchanger 5 when the thermal management system is in use, such that the refrigerant is cooled and condensed when flowing through the first heat exchanger 5.

The refrigerant circuit 2 also has a reservoir 6 downstream of the first heat exchanger 5 for drying and/or storing the refrigerant, a second heat exchanger 7 downstream of the reservoir 6, which heats and vaporizes the refrigerant with heat from a heat source (not shown), an expansion valve 8 upstream of the second heat exchanger 7 and downstream of the reservoir 6, and a refrigerant compressor 9 upstream of the first heat exchanger 5 and downstream of the second heat exchanger 7.

FIG. 1 also shows that the refrigerant circuit 2 has a cooling branch 10 with which the efficiency of the thermal management system 1 is increased, which connects the reservoir 6 to the compressor 9 in the manner of a bypass. This results in a secondary flow path 11 for the refrigerant from the reservoir 6 to the compressor 9 in the direction indicated by the arrows 3.

The cooling branch 10 contains a regulator 12 downstream of the reservoir, in particular a choke, a shutter, or preferably an electric expansion valve, which reduces the pressure and temperature of the refrigerant in the secondary flow 11, specifically in relation to the temperature and pressure of the refrigerant upstream of the regulator 12 and downstream of the reservoir 6.

FIG. 1 also shows that the thermal management system 1 contains a third heat exchanger 13, which is upstream of the expansion valve 8 and downstream of the reservoir in the refrigerant circuit 2, and is connected to the cooling circuit 10 upstream of the compressor 9 and downstream of the regulator 12, such that the refrigerant in the main flow path 3 and the secondary flow path 11 can flow through the third heat exchanger 12. The main flow path 3 and secondary flow path 11 pass by one another in the third heat exchanger 13 such that heat can be transferred from the main flow path 3 to the secondary flow path 11. This can be used to further lower the temperature of the refrigerant 3 exiting the first heat exchanger 5, after initial cooling in the first heat exchanger 5.

FIG. 1 also shows that the third heat exchanger 13 and first heat exchanger 5 form an integral unit 14. This results in a relatively inexpensive thermal management system 1 that is compact and light, which is of particular advantage for use in a vehicle due to the limited installation space and overall weight.

It is clear that the components of the thermal management system 1 described above are connected to one another, e.g. by tubes.

The embodiment of the thermal management system 1 shown in FIG. 1 also contains a second valve 16 upstream of the first heat exchanger 5 and downstream of the compressor 9, for controlling, i.e. specifically for shutting off, the refrigerant flow 3.

The thermal management system 1 also contains three pressure and temperature sensors 19, 20, 21, the first of which is upstream of the compressor 9 and downstream of the second heat exchanger 7. The second sensor 20 is upstream of the first heat exchanger and downstream of the compressor 9, and the third sensor 21 is in the cooling branch 10, upstream of the compressor 9 and downstream of the third heat exchanger 13. Purely by way of example, the thermal management system 1 also contains a heating circuit 17 with a refrigerant expansion valve 18, through which refrigerant circulates.

The specification can be readily understood with reference to the following numbered paragraphs:

Numbered Paragraph 1. A thermal management system (1) for a vehicle, in particular an electric vehicle, containing a refrigerant circuit (2) in which a refrigerant (3) circulates in a predefined direction (4), and which contains a first heat exchanger (5) that cools and condenses the refrigerant, wherein the refrigerant circuit (2) contains a reservoir (6) downstream of the first heat exchanger (5) for drying and/or storing the refrigerant, a second heat exchanger (7) downstream of the reservoir (6), which heats and vaporizes the refrigerant, an expansion valve (8) upstream of the second heat exchanger (6) and downstream of the reservoir (6), and a compressor (9) for the refrigerant that is upstream of the first heat exchanger (5) and downstream of the second heat exchanger (7), a cooling branch (10) that connects the reservoir (6) to the compressor (9), through which the refrigerant flows in a secondary flow path (11) from the reservoir (6) to the compressor (9), wherein the cooling branch (10) contains a regulator (12) downstream of the reservoir (6), which reduces the pressure and temperature of the refrigerant in the secondary path (11) through expansion, and a third heat exchanger (13) upstream of the expansion valve (8) and downstream of the reservoir (6) in the refrigerant circuit (2), which is also connected to the cooling branch (10) upstream of the compressor (9) and downstream of the regulator (12) and transfers heat from the refrigerant flow path (3) to the secondary flow path (11), wherein the third heat exchanger (12) is integrated in the first heat exchanger (5).

Numbered Paragraph 2. The thermal management system (1) according to Numbered Paragraph 1, characterized in that the third heat exchanger (13) and first heat exchanger (5) form an integral unit (14).

Numbered Paragraph 3. The thermal management system (1) according to Numbered Paragraph 1 or 2, characterized in that the third heat exchanger (13) is an evaporator for generating refrigerant vapor.

Numbered Paragraph 4. The thermal management system (1) according to any of the preceding Numbered Paragraphs, characterized in that the first heat exchanger (6) is an indirect heat exchanger, preferably a liquid-cooled condenser.

Numbered Paragraph 5. The thermal management system (1) according to any of the preceding Numbered Paragraphs, characterized in that the refrigerant circuit (2) contains a second valve (16) upstream of the first heat exchanger (5) and downstream of the compressor (9), for controlling the flow (3) of refrigerant, in particular a shut-off valve for shutting off the flow (3) of refrigerant.

Numbered Paragraph 6. The thermal management system (1) according to any of the preceding Numbered Paragraphs, characterized in that the regulator (12) is a choke, shutter, or preferably an electric expansion valve.

Numbered Paragraph 7. The thermal management system (1) according to any of the preceding Numbered Paragraphs, characterized in that the thermal management system (1) contains a heating circuit (17) through which a refrigerant circulates, and which is preferably connected to the compressor (9).

Numbered Paragraph 8. The thermal management system (1) according to any of the preceding Numbered Paragraphs, characterized in that the refrigerant circuit (2) contains a first sensor (19) upstream of the compressor (9) and downstream of the second heat exchanger (7) for detecting the pressure and temperature of the refrigerant in the refrigerant flow path (3), and/or the refrigerant circuit (2) contains a second sensor (20) upstream of the first heat exchanger (5) and downstream of the compressor (9) for detecting the pressure and temperature of the refrigerant in the refrigerant flow path (3), and/or the cooling branch (10) in the refrigerant circuit (2) contains a third sensor (21) upstream of the compressor (9) and downstream of the third heat exchanger (13) for detecting the pressure and temperature of the refrigerant in the secondary flow path (11).

Numbered Paragraph 9. An air conditioner or heat pump for a vehicle, containing at least one thermal management system (1) according to any or all of the preceding Numbered Paragraphs 1 to 8.

Numbered Paragraph 10. A vehicle containing an air conditioner or heat pump according to Numbered Paragraph 9.

### LIST OF REFERENCE SYMBOLS

1 thermal management system
2 refrigerant circuit
3 refrigerant flow path
4 direction of flow
5 first heat exchanger
6 reservoir
7 second heat exchanger
8 expansion valve
9 compressor
10 cooling branch
11 secondary flow path
12 regulator
13 third heat exchanger
14 unit
15 evaporator
16 second valve
17 heating circuit
18 refrigerant expansion valve
19 first sensor
20 second sensor
21 third sensor

1-10. (canceled)

11. A thermal management system for an electric vehicle, comprising a refrigerant circuit in which a refrigerant circulates in a predefined direction (4), and which comprises:
a first heat exchanger that is configured to cool and condense the refrigerant, wherein the refrigerant circuit contains a reservoir downstream of the first heat exchanger configured for drying and/or storing the refrigerant,
a second heat exchanger downstream of the reservoir, the second heat exchanger configured to heat and vaporize the refrigerant,
an expansion valve upstream of the second heat exchanger and downstream of the reservoir, and
a compressor for the refrigerant that is upstream of the first heat exchanger and downstream of the second heat exchanger,
a cooling branch connects the reservoir to the compressor, through which the refrigerant flows in a secondary flow path from the reservoir to the compressor, wherein the cooling branch comprises a regulator downstream of the reservoir, which is configured to reduce the pressure and temperature of the refrigerant in the secondary path through expansion, and
a third heat exchanger upstream of the expansion valve and downstream of the reservoir in the refrigerant circuit, the third heat exchanger is also connected to the cooling branch upstream of the compressor and downstream of the regulator and the third heat exchanger is configured to transfer heat from the refrigerant flow path to the secondary flow path, wherein the third heat exchanger is integrated in the first heat exchanger.

12. The thermal management system according to claim 11, wherein the third heat exchanger and first heat exchanger form an integral unit.

13. The thermal management system according to claim 11, wherein the third heat exchanger is an evaporator that is configured for generating refrigerant vapor.

14. The thermal management system according to claim 11, wherein the first heat exchanger is an indirect heat exchanger that is a liquid-cooled condenser.

15. The thermal management system according to claim 11, wherein the refrigerant circuit comprises a second valve upstream of the first heat exchanger and downstream of the compressor, the second valve is configured for controlling the flow of refrigerant, the second valve is a shut-off valve that is configured for shutting off the flow of refrigerant.

16. The thermal management system according to claim 11, wherein the regulator is a choke, shutter, or an electric expansion valve.

17. The thermal management system according to claim 11, further comprising a heating circuit through which a refrigerant circulates, and which is connected to the compressor.

18. The thermal management system according to claim 11, wherein the refrigerant circuit comprises a first sensor upstream of the compressor and downstream of the second heat exchanger, the first sensor is configured for detecting the pressure and temperature of the refrigerant in the refrigerant flow path, and/or
the refrigerant circuit comprises a second sensor upstream of the first heat exchanger and downstream of the compressor, the second sensor is configured for detecting the pressure and temperature of the refrigerant in the refrigerant flow path, and/or
the cooling branch in the refrigerant circuit comprises a third sensor upstream of the compressor and downstream of the third heat exchanger, the third sensor is configured for detecting the pressure and temperature of the refrigerant in the secondary flow path.

19. An air conditioner or heat pump for a vehicle, comprising at least one thermal management system according to claim 11.

20. A vehicle comprising the air conditioner or heat pump according to claim 19.
